(19) United States
(12) Patent Application Publication
(10) Pub. No.: US 2019/0059500 A1
(43) Pub. Date: Feb. 28, 2019

(54) NECKLINER FOR A HELMET

(71) Applicant: Ruroc Sports Limited, Gloucester (GB)

(72) Inventors: Daniel Rees, Gloucester (GB); Luke Ashley, Gloucester (GB); Matt Rees, Ross-on-Wye (GB); Jamie Pates, Gloucester (GB); Adam Taylor, Gloucester (GB); Bridget Rees, Ross-on-Wye (GB); Wayne Rees, Gloucester (GB)

(21) Appl. No.: 15/693,109

(22) Filed: Aug. 31, 2017

(51) Int. Cl. A42B 3/30; A42B 3/08; A42B 3/12; H04R 1/02; G06F 3/16

(52) U.S. Cl. CPC A42B 3/303; A42B 3/08; G06F 3/165; H04R 1/028; A42B 3/127

(57) ABSTRACT

A neckliner for a helmet incorporates a C-shaped body for fitting in the helmet around the back and sides of a neck of a wearer. The C-shaped body has a first end and a second end, a speaker for relaying sound to an ear of the wearer, a releasable fastener for releasably attaching the neckliner to the helmet, a first support portion and a second support portion. Each support portion has a proximal end and a distal end. The proximal end of the first support portion is attached to the first end of the C-shaped body. The proximal end of the second support portion is attached to the second end of the C-shaped body. The speaker is situated in a first corner formed between the first end of the C-shaped body and the first support portion for placement proximal to a first ear of the wearer in use.

### BACKGROUND OF THE INVENTION

### Field of the Invention

The invention is directed to a neckliner for a helmet.

### Background

It is common to wear a helmet to protect the head in the event of an impact, for example when taking part in certain sports such as skiing or snowboarding, or when riding motorcycles. To afford adequate protection, such helmets typically cover the entire head of the user, and include substantial padding and/or shock absorbing layers. They are therefore thick, for example greater than 2 cm in thickness. This can make it difficult for the wearer to hear sounds originating outside the helmet, as they are absorbed by the helmet, making communication more difficult.

When wearing a helmet, it is not possible to make or answer a phone call in the conventional way, by holding the mobile phone or handset adjacent to the ear and mouth, as the helmet covers the ear, obstructing this positioning of the mobile phone or handset and absorbing sound travelling to the user's ear

It can also be inconvenient or uncomfortable to use earphones or headphones while wearing such a helmet, as the helmet must fit tightly on the head of the wearer to provide adequate protection, meaning that there is minimal clearance between the wearer's ears and the inner surface of the helmet, so there is typically not enough space to comfortably accommodate an earphone or headphone without applying pressure to the wearer's ears, which can cause discomfort. Additionally, it can be difficult to put the helmet on or take it off without disturbing the position of the earphones or headphone.

It is an object of the invention to provide a helmet and a neckliner for a helmet with an integrated speaker and optionally a microphone, to reduce the above mentioned problems.

### SUMMARY OF THE INVENTION

According to a first aspect of the present invention, there is provided a neckliner for a helmet, comprising: a C-shaped body for fitting in the helmet around the back and sides of a neck of a wearer, the C-shaped body having a first end and a second end; a speaker for relaying sound to an ear of the wearer; a releasable fastener for releasably attaching the neckliner to the helmet; and a first support portion and a second support portion, each support portion having a proximal end and a distal end in which the proximal end of the first support portion is attached to the first end of the C-shaped body. The proximal end of the second support portion is attached to the second end of the C-shaped body, the distal end of each support portion is situated outside a plane defined by the C-shaped body, and the speaker is situated in a first corner formed between the first end of the C-shaped body and the first support portion for placement proximal to a first ear of the wearer in use.

The C-shaped body contacts the back and sides of the wearer's neck, and the interior of the helmet in use. It provides a padding for protection and comfort, and supports the helmet. The speaker can relay sound to the wearer, for example from a telephone conversation or a source of music or a radio station. This can allow the wearer to communicate with other people, for example other motorbike riders or skiers. The speaker can also allow the wearer to listen to music. The support portions provide further padding between the wearer's head and the helmet. This allows motorbike riders and sports players to communicate and listen to music without the use of separate earphones or headphones, allowing the helmet to be removed in one piece and making use more convenient and comfortable.

The speaker may be offset outwards from an inner surface of the neckliner.

This provides clearance for the wearer's ear or ears to prevent excess pressure from being applied to the wearer's ears. This also promotes ventilation within the helmet, reducing the chance of the wearer overheating and increasing the wearer's comfort.

The C-shaped body may include a first notch and a second notch, each notch being provided in an upper surface of the C-shaped body, the first notch being situated at the first corner and the second notch being situated at the second corner, the speaker being provided adjacent the first notch.

The notches provide a space for the wearer's ear, allowing for the clearance described above, while allowing support and protection to be provided between the helmet and the areas of the user's head surrounding the ears. The ear is received in the notch, and partially surrounded by the C-shaped body and the support portions.

The speaker may be fixed adjacent to the C-shaped body on a movable support. This allows the speaker to move slightly to accommodate users with larger ears.

The movable support may be provided as a webbing joining the first support portion to the first end of the C-shaped body and closing an outer side of the first notch.

The webbing holds the speaker in position while allowing it to move radially outwards from the head of the wearer slightly to accommodate users with larger ears. The webbing also increases the structural integrity of the neckliner by connecting the C-shaped body to the support portions.

The webbing may be joined to the C-shaped body and the support portion substantially at an outer edge of the body and support portion. In this way, an outer surface of the webbing may form a continuation of the outer surface of the body and the support portion, joining the outer surfaces of the body and the support portion together to form a substantially continuous outer surface.

The neckliner may further comprise first and second releasable fasteners for releasably attaching the neckliner to the helmet, in which the first releasable fastener is situated on the first support portion and the second releasable fastener is situated on the second support portion.

This allows the neckliner to be secured within the helmet, so that it does not move within the helmet or fall out of the helmet. The neckliner can also be removed from the helmet for cleaning or repair, or to be interchanged with an alternative neckliner. This feature allows the neckliner to be provided as an upgrade for existing helmets. The neckliner is a fully integrated system and may be provided as a standalone for insertion into an existing, helmet.

The first releasable fastener may be situated at the distal end of the first support portion and the second releasable fastener may be situated at the distal end of the second support portion. This allows the neckliner to be secured within the helmet so that the distal ends of the support portions do not move when the helmet is in use.

The neckliner may further comprise a third releasable fastener and a fourth releasable fastener, the third releasable fastener being situated at the proximal end of the first support portion and the fourth releasable fastener being situated at the proximal end of the second support portion.

This allows the proximal ends of the support portions to be attached to the inner surface of the helmet when in use. This reduces the chance that the first and second releasable fasteners may fail, and reduces the amount of movement available to the neckliner, so that the helmet is steadily supported on the wearer's head.

A distance from the distal end of the first support to the distal end of the second support may be greater than a distance from the proximal end of the first support to the proximal end of the second support.

This allows the support portions to conform to the curvature of the interior of the helmet, and provides clearance around the wearer's face for improved ventilation and comfort. While this is the case when the neckliner is in an unstressed neutral position, and when the neckliner is fitted within the helmet for use, it is envisaged that the neckliner may in some embodiments be made from a deformable soft material.

The neckliner may further comprise a microphone for receiving the voice of the wearer. This allows the neckliner to be used for two-way communication. For example, the wearer may make and receive telephone calls when used in conjunction with an external device, such as a mobile phone. Alternatively, a telecommunication device could be provided integral to the helmet, for example a UHF radio.

The microphone may be situated on a front edge of either the first support portion or the second support portion. This positions the microphone close to the user's mouth, so that the user's voice may be received clearly and loudly by the microphone. Preferably, the microphone may be provided inside a fabric outer cover of the neckliner. The outer cover of the neckliner in this way acts as a windshield for the microphone, reducing background noise.

The neckliner may further comprise an electronic communication unit. The electronic communication unit may be adapted to relay information from an external device to the speaker. This allows a separate device situated outside of the helmet, for example a mobile phone, to be used to play music or make telephone calls, or for other functions. Alternatively, the electronic communication unit integrated into the neckliner may be a stand-alone device, for example a UHF radio or even a mobile phone could be provided either integrated into the neckliner or another part of the helmet, so that the neckliner may be used for communication without the need for an external device.

The neckliner may further comprise a control panel including at least one button. This allows the wearer to control the functions of the neckliner, and possibly of another device such as a mobile telephone. Advantageously, the wearer does not need to access the mobile phone to control it. For example, the user could answer a call, change a playback volume or skip a track (when listening to music) using the control panel without accessing the mobile phone. This is particularly advantageous as the applications for which such helmets are intended often require that a mobile phone is secured, for example in a sealed pocked.

The control panel may be situated on a bottom surface of the C-shaped body and may be adapted to be accessible to the wearer's hands when the helmet is worn. This allows the wearer to access the control panel without removing the helmet, improving the convenience and safety of the device. The control panel may be situated at the back of the helmet in use, i.e. behind the wearer's neck.

The or each button may protrude from a bottom surface of the control panel. This allows the buttons to be easily located and activated without sight of the control panel, that is, by touch alone. This in turn allows the control panel to be located at the back of the user's neck, where its bulk can be accommodated less obtrusively. Preferably the buttons are large enough, and spaced apart enough, to be operated while wearing gloves.

The or each button may include raised indicia for identifying a functionality of the button. This allows the functionality of each button to be identified by touch alone, with similar advantages to those described above.

According to a second aspect of the invention, there is provided a helmet including a neckliner, the neckliner comprising: a C-shaped body having a first end and a second end; a speaker for relaying sound to an ear of a wearer; first and second releasable fasteners; a first support portion and a second support portion, each support portion having a proximal end and a distal end, and the helmet comprising first and second releasable fasteners corresponding to the first and second releasable fasteners of the neckliner, for releasably fastening the neckliner into the helmet, in which the proximal end of the first support portion is attached to the first end of the C-shaped body. The proximal end of the second support portion is attached to the second end of the C-shaped body, the distal end of each support portion is situated outside a plane defined by the C-shaped body, the speaker is situated in a first corner formed between the first end of the C-shaped body and the first support portion for placement proximal to a first ear of the wearer in use, between the inside of the helmet and the wearer's ear.

The helmet may include a rear portion having an inside surface, a first side portion having an inside surface and a second side portion having an inside surface, in which the inside surfaces are joined in a C shape for fitting around the back and sides of a wearer's head, and in which a curved outer surface of the C-shaped body of the neckliner contacts a lower portion of each of the inside surfaces.

Any of the optional features of the neckliner of the first aspect of the invention may be incorporated into the neckliner in combination with the helmet according to the second aspect of the invention

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

For a better understanding of the present invention, and to show more clearly how it may be carried into effect, reference will now be made by way of example only to the accompanying drawings, in which:

FIG. 1 shows a front perspective view of a neckliner for a helmet;

FIG. 2 shows a plan view from above of the neckliner of FIG. 1;

FIG. 3 shows a front plan view of the neckliner of FIG. 1;

FIG. 4 shows a bottom plan view of the neckliner of FIG. 1;

FIG. 5 shows a side plan view of the neckliner of FIG. 1;

FIG. 6 shows a perspective side view of a portion of the neckliner of FIG. 1;

FIG. 7 shows a perspective rear view of the neckliner of FIG. 1, the neckliner having been turned over relative to FIG. 1;

FIG. 8 shows a bottom plan view of a portion of the neckliner of FIG. 1 with the micro-USB port seal in place; and

FIG. 9 shows a bottom plan view of a portion of the neckliner of FIG. 1 with the micro-USB port seal removed.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations; modifications, improvements are within the scope of the present invention.

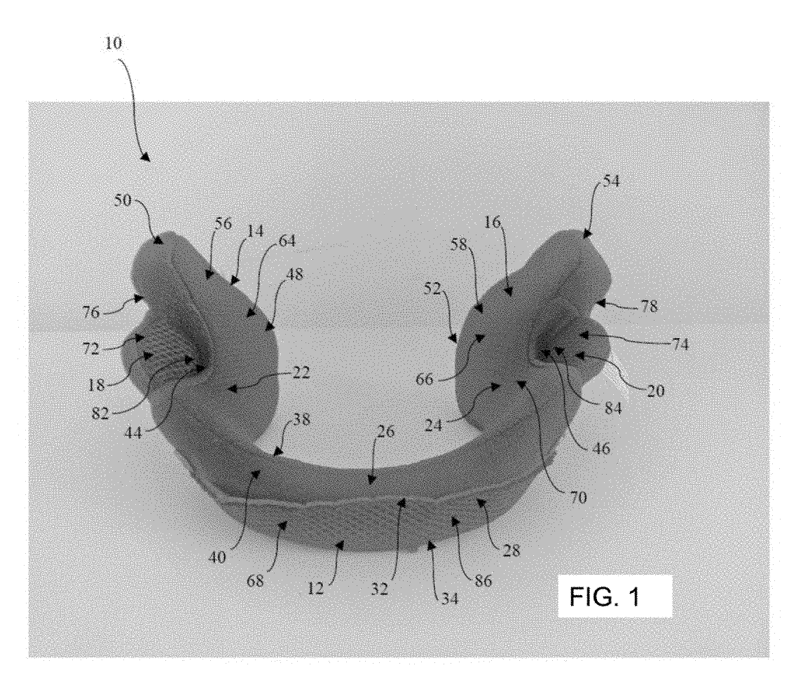

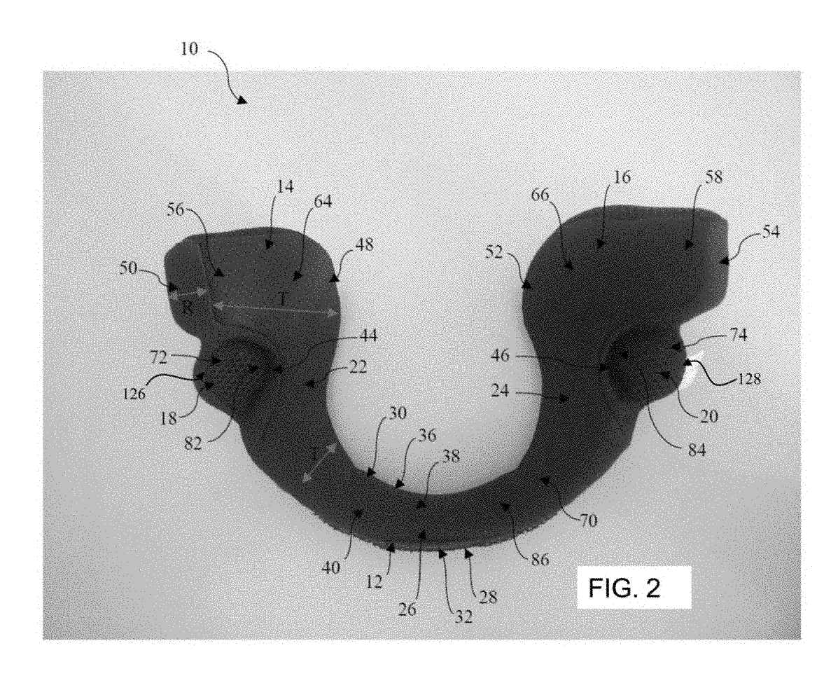

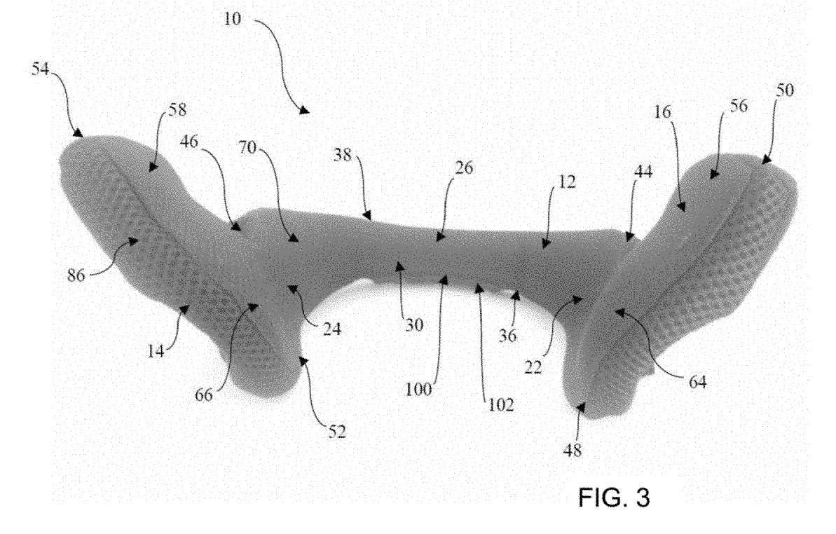

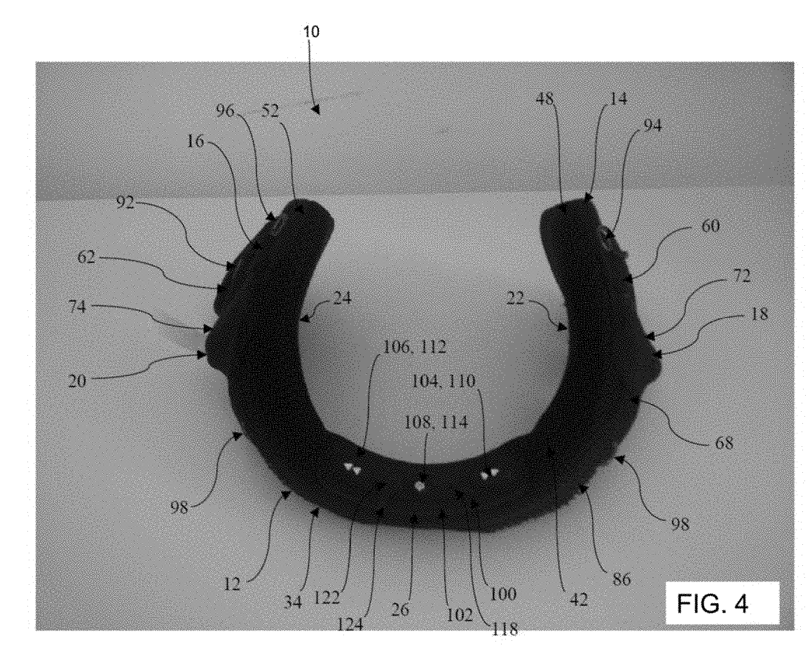

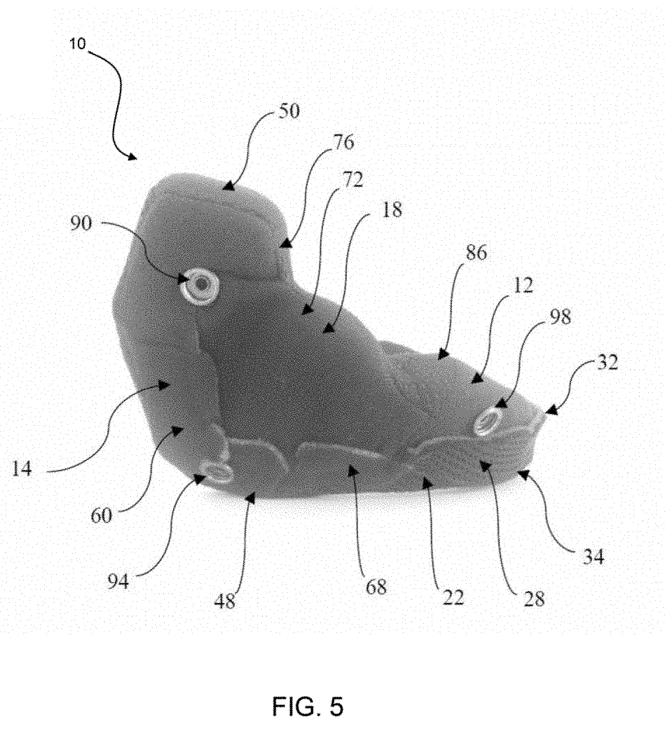

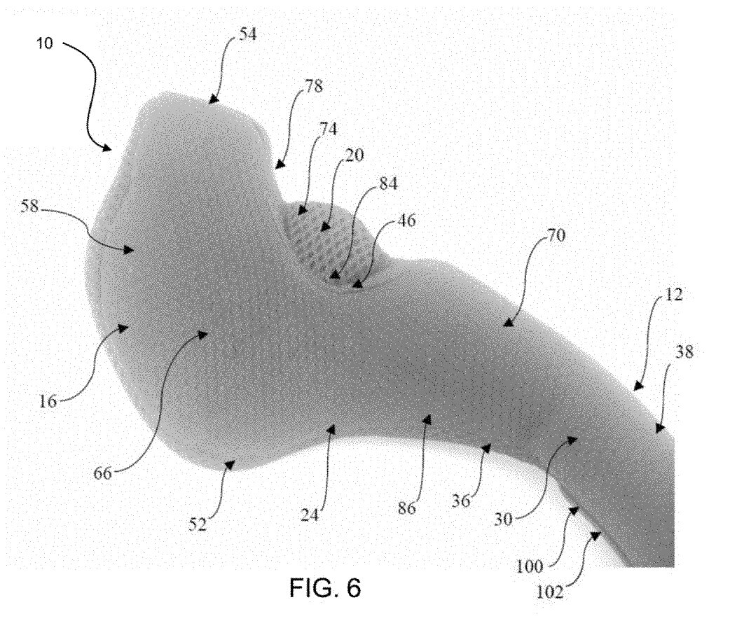

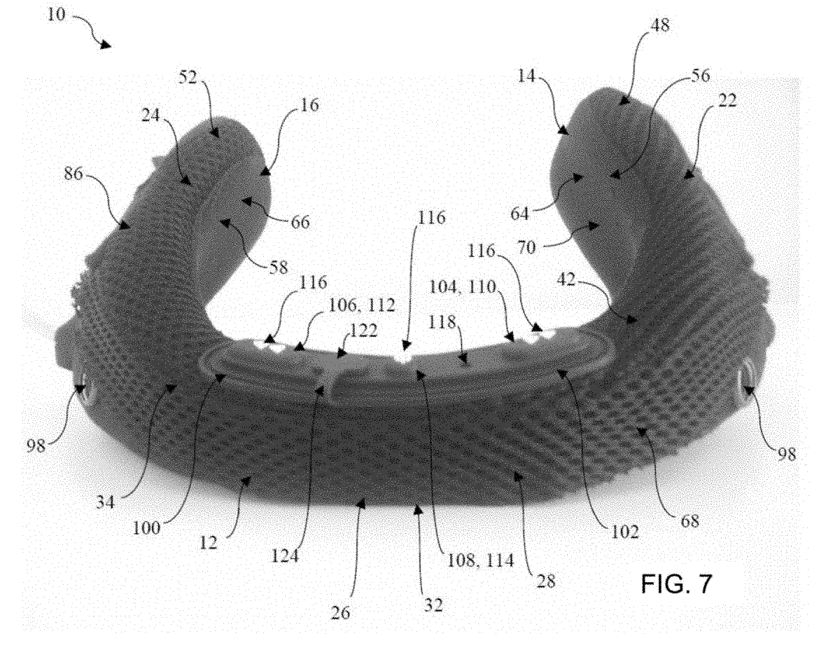

Referring to FIGS. 1 to 9, a neckliner is indicated generally at 10. The neckliner 10 includes a C-shaped body 12, a first support portion 14, a second support portion 16, a first speaker 18 and a second speaker 20. These parts and their interrelations are described in detail below.

The C-shaped body 12 is a curved elongate body, substantially in the form of a C. It has a first end 22 and a second end 24. The height (in a tangential direction relative to the head of the user, direction T) of the C-shaped body 12 is not constant along its length. The height is smallest at the centre 26 of the body 12 and gradually becomes larger towards each end 22, 24 of the body 12. In use, the ends 22, 24 of the body 12 contact lower side portions of a user's head, for example the backs of the wearer's cheeks or the region directly below the wearer's ears. The thickness (in a radial direction relative to the head of the user, direction R) of the body 12 remains substantially the same along the length of the body 12. The C-shaped body 12 has a curved outer surface 28 and a curved inner surface 30. The curved outer surface 28 has an upper edge 32 and a lower edge 34. The curved inner surface 30 has an upper edge 38 and a lower edge 36. An upper surface 40 joins the upper edges 32, 38 of the outer surface 28 and the inner surface 30. The upper surface 40 is curved upwards towards each end 22, 24 of the C-shaped body 12, increasing the height of the body along its length. A lower surface 42 joins the lower edges 34, 36 of the outer surface 28 and the inner surface 30. The lower surface 42 is substantially flat, and sits in an approximately horizontal plane in use.

A first notch 44 is provided on the upper surface 40 of the C-shaped body 12 near the first end 22 of the C-shaped body 12. A second notch 46 is provided on the upper surface 40 of the C-shaped body 12 near the second end 24 of the C-shaped body 12. Each notch 44, 46 extends between the outer surface 28 and the inner surface 30 of the C-shaped body 12. Each notch 4, 46 has the form of a semi-circular cut-out in the C-shaped body 12.

Each of the first and second support portions 14, 16 is an elongate member with a height (in tangential direction T), a width which is smaller than the height and a thickness (in radial direction R) that is smaller than the width. Each support portion 14, 16 has a proximal end 48, 52 and a distal end 50, 54. Each support portion 14, 16 has an inner surface 56, 58 and an outer surface 60, 62. Each support portion 14, 16 curves outwards from the proximal end 48, 52 to the distal end 50, 54. The distal end 50, 54 of each support portion 14, 16 is displaced outwardly relative to the respective proximal end 48, 52 of each support portion 14, 16. Although this is the case when the neckliner is in an unstressed neutral position, the neckliner, and in particular the C-shaped body, may be made from a soft deformable material, and the shape of the neckliner may therefore change in use. The inner surface 56, 58 of each support portion 14, 16 includes a convex portion 64, 66. In this case, convex means bulging towards the interior of the helmet, that is, towards the wearer's head when in use. Each convex portion 64, 66 is situated closer to each respective proximal end 48, 52 than to each respective distal end 50, 54.

The proximal end 48 of the first support portion 14 is joined to the first end 22 of the C-shaped body 12. The proximal end 52 of the second support portion 16 is joined to the second end 24 of the C-shaped body 12. The outer surface 60, 62 of each support portion 14, 16 is continuous with the outer surface 28 of the C-shaped body 12. The inner surface 56, 58 of each support portion 14, 16 is continuous with the inner surface 30 of the C-shaped body 12. The inner surfaces 56, 58 of the support portions 14, 16 face each other. The inner surface 30 of the C-shaped body 12 and the inner surfaces 56, 58 of the support portions form a single curved inner surface 70. The first notch 44 of the C-shaped body 12 is adjacent to the first support portion 14, and the second notch 46 of the C-shaped body 12 is adjacent to the second support portion 16. The distal ends 50, 54 of the support portions 14, 16 are free. The support portions 14, 16 extend out of the plane of the C-shaped body 12. The support portions 14, 16 extend on the same side of the C-shaped body 12, upwardly towards the top of the helmet when installed.

Although the support portions 14, 16 and the C-shaped body 10 are described here as distinct elements, the support portions 14, 16 are essentially provided as extensions of the C-shaped body 12 in this embodiment. The overall shape of the neckliner 10 is that of an elongate member having a hook at each end, bent into the shape of a C so that the hooks point in the same direction, upwards out of the plane of the C.

The first speaker 18 is situated adjacent to the first notch 44. The second speaker 20 is situated adjacent to the second notch 46. Each speaker 18, 20 is substantially flat, that is, a thickness of each speaker 18, 20 is significantly less than the thickness of the C-shaped body 12. Each speaker 18, 20 is situated substantially in-line with the outer surface 28 of the C-shaped body 12. Each speaker 18, 20 is housed within a webbing 72, 74. Each webbing 72, 74 is flexible. Each webbing 72, 74 joins a rear outer edge 76, 78 of each respective support portion 14, 16 to the upper edge 32 of the outer surface 28 of the C-shaped body 12. An outer surface 126, 128 of each webbing 72, 74 is continuous with the outer surface 60, 62 of each respective support portion 14, 16. The outer surface 126, 128 of each webbing 72, 74 is continuous with the outer surface 28 of the C-shaped body 12. Each webbing 72, 74 closes each respective notch 44, 46, to form a cavity having a floor and a wall, for fitting below and over an ear. Each speaker 18, 20 is oriented so as to be tilted outwards from the C-shaped body 12, that is, a bottom edge 82, 84 of each speaker 18, 20 is joined to the outer surface 28 of the C-shaped body 12, and each speaker 18, 20 extends outwards and upwards therefrom.

The neckliner 10 is covered by a continuous covering 86. The covering 86 is made of fabric. The covering 86 includes a foam padding. Each webbing 72, 74 is continuous with the covering 86. In this embodiment, each webbing 72, 74 is formed as an extension of the covering 86.

The neckliner 10 also includes releasable fasteners 90, 92, 94, 96, 98 for securing the neckliner 10 within the helmet. Each releasable fastener 90, 92, 94, 96, 98 is provided on the outer surface 68 of the neckliner 10. In this embodiment, the releasable fasteners 90, 92, 94, 96, 98 are push studs. At least one releasable fastener 90, 92, 94, 96 is situated on each support portion 14, 16. Preferably at least one releasable fastener 90, 92 is situated near the distal end 50, 54 of each support portion 14, 16, on the outer surface 60, 62 of each support portion 14, 16. Preferably, two releasable fasteners 90, 92, 94,:96 are provided on each support portion 14, 16. In this embodiment, a first releasable fastener 90, 92 is situated on the outer surface 60, 62 of each support portion 14, 16 close to the distal 50, 54 end of the respective support portion 14, 16, and a second releasable fastener 94, 96 is situated on the outer surface 60, 62 of each support portion 14, 16 near the proximal end 48, 52 of the respective support portion. Preferably, at least one releasable fastener 98 is situated on the outer surface 28 of the C-shaped body 12. In this embodiment, two releasable fasteners 98 are situated on the outer surface 28 of the C-shaped body 12. One releasable fastener 98 is situated near the first end 22 of the C-shaped body 12 and another releasable fastener 98 is situated near the second end 24 of the C-shaped body 12.

Although in this embodiment the releasable fasteners 90, 92, 94, 96, 98 are described as being discrete releasable fasteners 90, 92, 94, 96, 98, specifically push-studs, they could be provided as portions of a single larger releasable fastener, for example a strip of a hook-and-loop material or a zip.

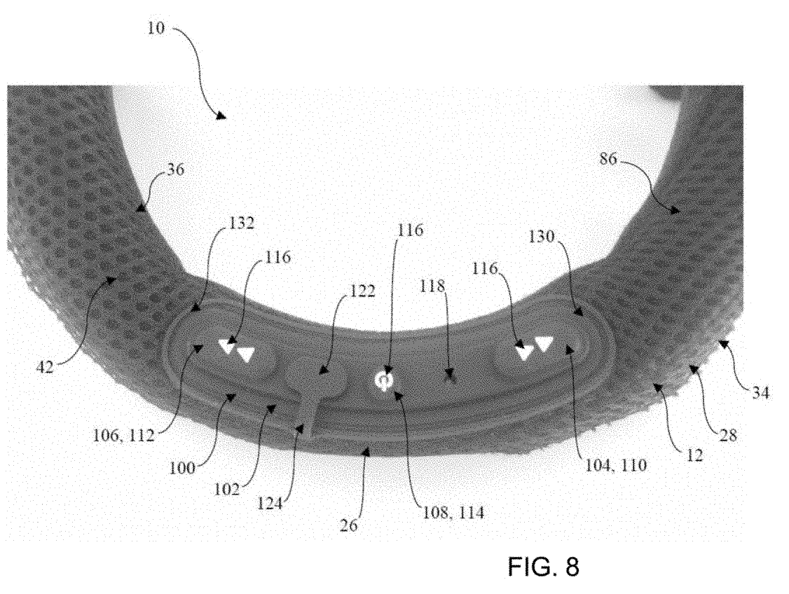

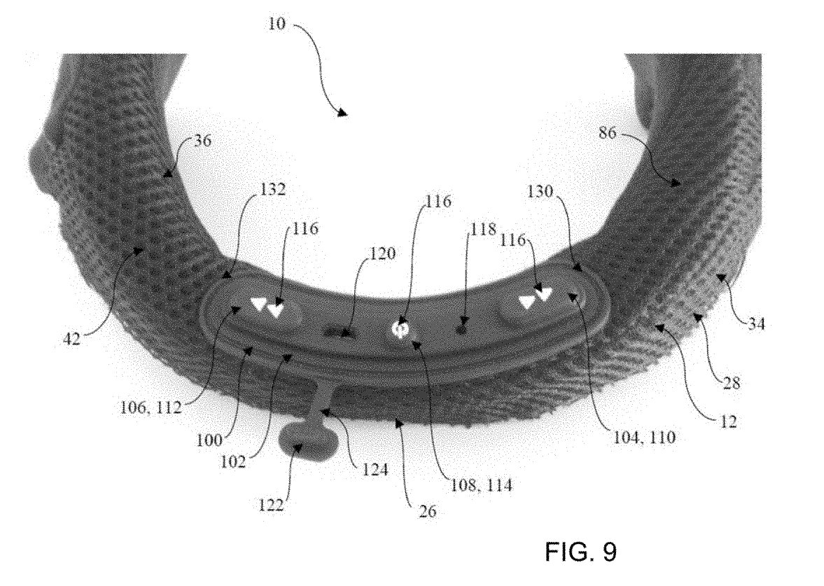

The neckliner 10 also includes a control panel 100. The control panel 100 is situated on the lower surface 42 of the C-shaped body 12. The control panel 100 includes an elongate resilient cover 102 having a first end 130 and a second end 132. The cover 102 is stitched to the C-shaped body 12. The cover 102 is curved. In this embodiment. the cover 102 is made of silicone. The control panel 100 includes at least one button. In this embodiment, there are three buttons 104, 106, 108. This embodiment includes a first button 104 near the first end 130 of the cover 102, a second button 106 near the second end 132 of the cover 102, and a third button 108 in the middle of the cover 102. The resilient cover 102 covers the buttons 104, 106, 108 and includes projections 110, 112, 114 corresponding to the buttons 104, 106, 108. The third button 108 is a power button 108 for turning the device on and off. The projections 110, 112, 114 of the resilient cover 102 are raised proud of the lower surface 42 of the C-shaped body 12. Each projection 110, 112, 114 includes raised indicia 116 for indicating a functionality of the button 104, 106, 108 associated with the respective projection 110, 112, 114. The control panel 100 includes an LED 118. The control panel 100 also includes a micro-USB socket 120. The cover 102 includes a seal 122 for the micro-USB socket 120. The seal 122 is connected to the rest of the cover 102 via a strap 124 of silicone. The seal 122 is shown inserted into the micro-USB socket 120 in FIG. 8, and is shown removed in FIG. 9. Although three buttons 104, 106, 108 are described here, there could be more or fewer. There could be a slider or selector switch in addition to or instead of the buttons 104, 106, 108.

The neckliner 10 also includes a microphone (not shown). The microphone is situated on one of the support portions 14, 16. The microphone is situated beneath the covering 86 of the neckliner 10.

The neckliner 10 also includes a wireless communication system (not shown). The wireless communication system is housed within the neckliner 10. Preferably, the wireless communication system is housed within the C-shaped body 12. The wireless communication system may use the Bluetooth (RTM) standard. The wireless communication system is configured to relay sound information from a source outside of the helmet, for example a mobile phone, to the speakers. The wireless communication system is preferably further adapted to relay sound information from the microphone to a device outside of the helmet, for example a mobile phone. The sound information may be a telephone call for example, or alternatively it may be music. Alternatively, the wireless communication system could be a UHF radio for communicating with other radio users.

The neckliner 10 may in some embodiments include a navigation system. The navigation system is preferably housed within the neckliner 10, and is most preferably housed within the C-shaped body 12. The navigation system may include a GPS receiver, for example. The navigation system may be configured to cause the speakers to relay verbal directions to the wearer.

The speakers 18, 20 could be used for relaying information to the wearer, such as location information, information about a speed of the wearer, or information relating to a sport the wearer is participating in, for example a lap time. The speakers 18, 20 could relay weather information, which could include an automatic warning if bad weather is forecast. The speakers 18, 20 could inform the wearer of the locations of nearby speed cameras, or warn the wearer if his speed exceeds a safe or legal level.

A conventional helmet includes a top portion, a back portion, and first and second side portions, each portion having an inner surface. The top, back and side portions are connected together to form a shell having a front opening for the wearer's face and a bottom opening for the wearer's neck. The back and side portions each have a bottom edge. The bottom edges of the back and side portions are joined to define the bottom opening. The front opening and the bottom opening may be continuous, i.e. an open-face helmet, or they may be separate openings, i.e. a full-face helmet. The inner surfaces of the back portion and the side portions are typically joined continuously to form a single curved inner surface. In use, the neckliner 10 is inserted into the interior of the helmet. The outer surface 28 of the C-shaped body 12 contacts the inner surfaces of the back and side portions of the helmet. The C-shaped body 12 is situated close to the bottom edges of the back and side portions of the helmet. The support portions 14, 16 contact the respective inner surfaces of the respective side portions of the helmet. The releasable fasteners 90, 92, 94, 96, 98 engage with corresponding releasable fasteners situated on the inner surface of the helmet. The C-shaped body 12 defines an opening for the wearer's neck. The inner surface 70 of the C-shaped body 12 contacts the back and sides of the wearer's neck. The inner surfaces 56, 58 of the support portions 14, 16 are adjacent to the cheeks of the wearer.

The neckliner therefore provides padding and protection for the wearer's head, and allows the wearer to communicate electronically or listen to music without having to use separate headphones or earphones, allowing the helmet to be removed in one piece.

These embodiments are provided by way of example only, and various changes and modifications will be apparent to persons skilled in the art without departing from the scope of the present invention as defined by the appended claims.

What is claimed is:

1. A neckliner for a helmet, comprising:
a C-shaped body for fitting in the helmet around the back and sides of a neck of a wearer, the C-shaped body having a first end and a second end,
a speaker for relaying sound to an ear of the wearer,
a releasable fastener for releasably attaching the neckliner to the helmet,
a first support portion, and
a second support portion, wherein each of said first and second support portions has a proximal end and a distal end,
wherein the proximal end of the first support portion is attached to the first end of the C-shaped body, the proximal end of the second support portion is attached to the second end of the C-shaped body, the distal end of each support portion is situated outside a plane defined by the C-shaped body, the speaker is situated in a first corner formed between the first end of the C-shaped body and the first support portion for placement proximal to a first ear of the wearer in use.

2. The neckliner as claimed in claim 1, wherein the speaker is offset outwards from an inner surface of the neckliner.

3. The neckliner as claimed in claim 2, wherein the C-shaped body includes a first notch and a second notch, each notch being provided in an upper surface of the C-shaped body, the first notch being situated at the first corner and the second notch being situated at the second corner, the speaker being provided adjacent to the first notch.

4. The neckliner as claimed in claim 3, wherein the speaker is fixed adjacent to the C-shaped body on a movable support, the movable support being provided as a webbing joining the first support portion to the first end of the C-shaped body and closing an outer side of the first notch.

5. The neckliner as claimed in claim 1, wherein the speaker N fixed adjacent to the C-shaped body on a movable support.

6. The neckliner as claimed in claim 1, further comprising first and second releasable fasteners for releasably attaching the neckliner to the helmet, in which the first releasable fastener is situated on the first support portion and the second releasable fastener is situated on the second support portion.

7. The neckliner as claimed in claim 6, wherein the first releasable fastener is situated at the distal end of the first support portion and the second releasable fastener is situated at the distal end of the second support portion.

8. The neckliner as claimed in claim 7, further comprising a third releasable fastener and a fourth releasable fastener, in which the third releasable fastener is situated at the proximal end of the first support portion and the fourth releasable fastener is situated at the proximal end of the second support portion.

9. The neckliner as claimed in claim 1, wherein a distance from the distal end of the first support to the distal end of the second support is greater than a distance from the proximal end of the first support to the proximal end of the second support.

10. The neckliner as claimed in claim 1, further comprising a microphone for receiving the voice of the wearer.

11. The neckliner as claimed in claim 10, wherein the microphone is situated on a front edge of either the first support portion or the second support portion.

12. The neckliner as claimed in claim 1, further comprising an electronic communication unit, adapted to relay information to the speaker.

13. The neckliner as claimed in claim 1, further comprising a control panel including at least one button.

14. The neckliner as claimed in claim 13, wherein the control panel is situated on a bottom surface of the C-shaped body and is adapted to be accessible to the wearer's hands when the helmet is worn.

15. The neckliner as claimed in claim 13, wherein the or each button protrudes from a bottom surface of the control panel.

16. The neckliner as claimed in claim 13, wherein the or each button includes raised indicia for identifying a functionality of the button.

17. A helmet including a neckliner, the neckliner comprising:
a C-shaped body having a first end and a second end,
a speaker for relaying sound to an ear of a wearer,
first and second releasable fasteners,
a first support portion,
a second support portion,
wherein each of said first and second support portions has a proximal end and a distal end, and
wherein the helmet comprises a first and second releasable fasteners corresponding to the first and second releasable fasteners of the neckliner, for releasably fastening the neckliner to the helmet, and
wherein the proximal end of the first support portion is attached to the first end of the C-shaped body, the proximal end of the second support portion is attached to the second end of the C-shaped body, the distal end of each support portion is situated outside a plane defined by the C-shaped body, the speaker is situated in a first corner formed between the first end of the C-shaped body and the first support portion for placement proximal to a first ear of the wearer in use, between the inside of the helmet and the wearer's ear.

18. The helmet as claimed in claim 17, including a rear portion having an inside surface, a first side portion having an inside surface and a second side portion having an inside surface, in which the inside surfaces are joined in a C shape for fitting around the back and sides of a wearer's head, and in which a curved outer surface of the C-shaped body of the neckliner contacts a lower portion of each of the inside surfaces.

19. The helmet as claimed in claim 17, wherein the speaker is offset outwards from an inner surface of the neckliner.

20. The helmet as claimed in claim 17, wherein the C-shaped body includes a first notch and a second notch, each notch being provided in an upper surface of the C-shaped body, the first notch being situated at the first corner and the second notch being situated at the second corner, the speaker being provided adjacent to the first notch.
